(19) United States
(12) Patent Application Publication
(10) Pub. No.: US 2025/0058655 A1
(43) Pub. Date: Feb. 20, 2025

(54) ELECTRIC WORK MACHINE

(71) Applicant: KOMATSU LTD., Minato-ku, Tokyo (JP)

(72) Inventor: Masataka SOGA, Minato-ku, Tokyo (JP)

(73) Assignee: KOMATSU LTD., Minato-ku, Tokyo (JP)

(21) Appl. No.: 18/720,859

(22) PCT Filed: Dec. 20, 2022
(86) PCT No.: PCT/JP2022/046816

§ 371 Date: Jun. 17, 2024

(30) Foreign Application Priority Data
Dec. 24, 2021 (JP) 2021-211123

(51) Int. Cl. B60L 50/60; E02F 9/08

(52) U.S. Cl. CPC B60L 50/66; E02F 9/0866; B60L 2200/40

(57) ABSTRACT

A battery frame includes a first bracket supported by a first damper mount and a second bracket supported by a second damper mount. The battery frame is provided with a first surface and a second surface opposed to each other. The first bracket is arranged on the first surface and the second bracket is arranged on the second surface.

### TECHNICAL FIELD

The present disclosure relates to an electric work machine.

### BACKGROUND ART

For example, Japanese Patent Laying-Open No. 2021-80691 (PTL 1) discloses a construction in which a battery is supported on a machine-body frame with an elastic mount being interposed in an electric drive hydraulic excavator. In PTL 1, a shelf is provided on the machine-body frame, and the battery is supported on a shelf plate which forms a shelf, with the elastic mount and a supporting plate being interposed.

### CITATION LIST

### PATENT LITERATURE

PTL 1: Japanese Patent Laying-Open No. 2021-80691

### SUMMARY OF INVENTION

### Technical Problem

In a battery support structure in PTL 1, when an acceleration is applied to a work machine, leaning (tilt) of the battery toward front, rear, left, and right sides tends to occur. When leaning of the battery becomes great, the battery may interfere with a component (a harness, a pipe, or the like) therearound. Therefore, a large space on the front, rear, left, and right sides of the battery should be secured, which leads to poor efficiency in use of the space. In addition, when leaning of the battery becomes great, a great uneven load is applied to the elastic mount, which increases a stroke of the elastic mount. When leaning of the battery becomes greater, the machine-body frame swings and a sensory aspect to sense an operation by an operator deteriorates.

An object of the present disclosure is to provide an electric work machine capable of achieving suppression of leaning of a battery.

### Solution to Problem

An electric work machine in the present disclosure includes a first damping member and a second damping member and a battery frame. The battery frame includes a first bracket supported by the first damping member and a second bracket supported by the second damping member. The battery frame is provided with a first surface and a second surface opposed to each other. The first bracket is arranged on the first surface and the second bracket is arranged on the second surface.

### Advantageous Effects of Invention

According to the present disclosure, the electric work machine capable of achieving suppression of leaning of a battery can be obtained.

### BRIEF DESCRIPTION OF DRAWINGS

FIG. 1 is a perspective view schematically showing a construction of an electric excavator in one embodiment of the present disclosure.

FIG. 2 is a perspective view showing a construction of a battery structure body and a revolution frame in the electric excavator shown in FIG. 1.

FIG. 3 is an exploded perspective view of the battery structure body shown in FIG. 2.

FIG. 4 is a rear view showing a construction of the battery structure body shown in FIG. 2.

FIG. 5 is (A) a side view and (B) a plan view showing a first example of arrangement of a bracket in a battery frame.

FIG. 6 is a side view showing a second example of arrangement of the bracket in the battery frame.

FIG. 7 is a front view showing a third example of arrangement of the bracket in the battery frame.

FIG. 8 is a diagram showing a battery support structure in a comparative example.

### DESCRIPTION OF EMBODIMENTS

An embodiment of the present disclosure will be described below with reference to the drawings.

In the specification and the drawings, the same or corresponding components have the same reference characters allotted and redundant description will not be repeated. For the sake of convenience of description, features may not be shown or may be simplified in the drawings. At least a part of an embodiment and a modification may freely be combined.

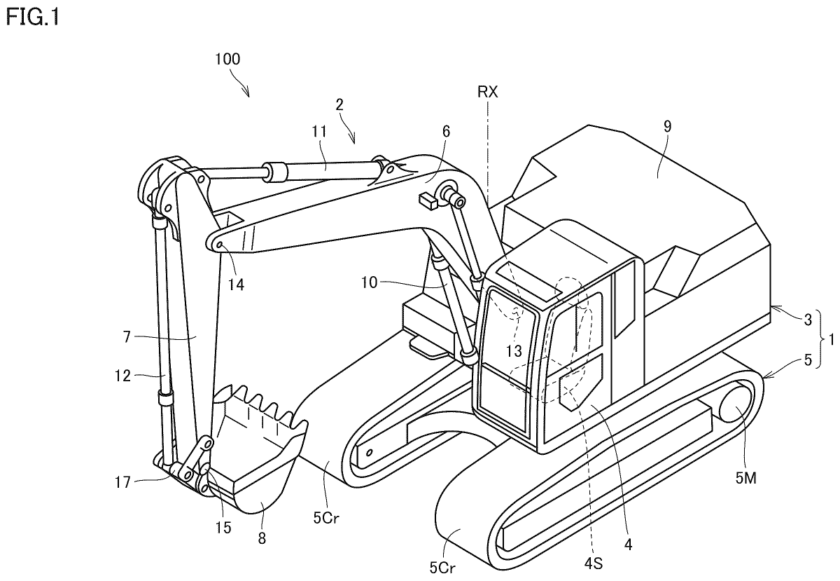

In the description below, “upward/upper/above”, “downward/lower/below”, “front”, “rear”, “left”, and “right” indicate directions with an operator seated in an operator's seat 4S in an operator's cab 4 shown in FIG. 1 being defined as the reference. An electric work machine 100 may be an electric excavator or an electric wheel loader. Electric work machine 100 may be an electric drive work machine including an electric motor as a drive source or a hybrid work machine including an engine and an electric motor as drive sources. Electric work machine 100 may be of a type in which a hydraulic actuator is activated with drive force from the electric motor or of a type in which an electric actuator is activated with drive force from the electric motor.

### Construction of Electric Excavator

A construction of an electric excavator as an exemplary electric work machine in the present embodiment will initially be described with reference to FIG. 1.

FIG. 1 is a perspective view schematically showing a construction of an electric excavator in one embodiment of the present disclosure. As shown in FIG. 1, an electric excavator 100 includes a main body 1 and a work implement 2 activated by a hydraulic pressure. Main body 1 includes a revolving unit 3 and a travel unit 5.

Travel unit 5 includes a pair of crawler belts 5Cr and a travel motor 5M. Electric excavator 100 can travel by rotation of crawler belts 5Cr. Travel motor 5M is provided as the drive source of travel unit 5. Travel motor 5M is a hydraulic motor activated by a hydraulic pressure. Travel unit 5 may include a wheel (tire).

Revolving unit 3 is arranged on travel unit 5 and supported by travel unit 5. Revolving unit 3 is revolvable with respect to travel unit 5 around a revolution axis RX by a revolution motor (not shown). The revolution motor is a hydraulic motor activated by a hydraulic pressure. Revolution axis RX is a virtual straight line defined as a center of revolution of revolving unit 3. Travel motor 5M or the revolution motor may be an electric motor.

Revolving unit 3 is provided with operator's cab 4 (cab). Operator's seat 4S where the operator is seated is provided in operator's cab 4. The operator (occupant) who rides in operator's cab 4 can control a work implement 2, control revolving unit 3 to perform a revolution operation with respect to travel unit 5, and control travel unit 5 to run electric excavator 100. Electric excavator 100 may remotely be controlled.

Work implement 2 is supported by revolving unit 3. Work implement 2 includes a boom 6, an arm 7, and a bucket 8. Work implement 2 further includes a boom cylinder 10, an arm cylinder 11, and a bucket cylinder 12.

Boom 6 is pivotably connected to main body 1. Specifically, boom 6 has a base end pivotably connected to revolving unit 3 with a boom foot pin 13 being defined as a fulcrum. Arm 7 is pivotably connected to boom 6. Specifically, arm 7 has a base end pivotably connected to a tip end of boom 6 with a boom top pin 14 being defined as a fulcrum. Bucket 8 is rotatably connected to arm 7. Specifically, bucket 8 has a base end pivotably connected to a tip end of arm 7 with an arm top pin 15 being defined as a fulcrum.

Boom cylinder 10 has one end connected to revolving unit 3 and has the other end connected to boom 6. Boom 6 can be driven with respect to main body 1 by boom cylinder 10. This drive can pivot boom 6 in an upward/downward direction with respect to revolving unit 3, with boom foot pin 13 being defined as the fulcrum.

Arm cylinder 11 has one end connected to boom 6 and has the other end connected to arm 7. Arm 7 can be driven with respect to boom 6 by arm cylinder 11. This drive can pivot arm 7 in the upward/downward direction or a forward/rearward direction with respect to boom 6, with boom top pin 14 being defined as the fulcrum.

Bucket cylinder 12 has one end connected to arm 7 and has the other end connected to a bucket link 17. Bucket 8 can be driven with respect to arm 7 by bucket cylinder 12. This drive can pivot bucket 8 in the upward/downward direction with respect to arm 7, with arm top pin 15 being defined as the fulcrum.

Each of boom cylinder 10, arm cylinder 11, and bucket cylinder 12 is a hydraulic cylinder and driven by a hydraulic pressure.

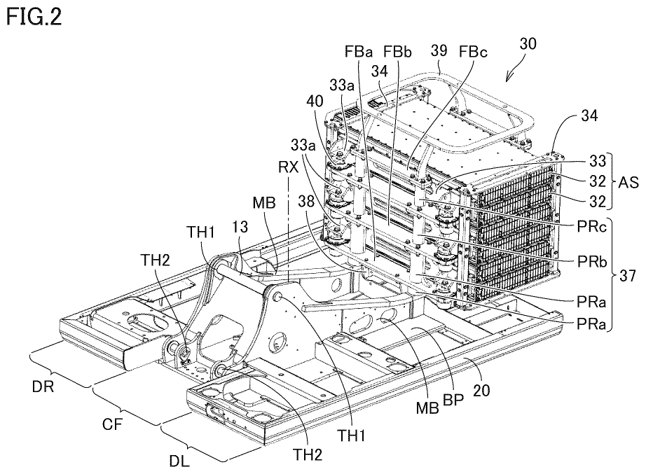

Revolving unit 3 includes an exterior cover 9. Exterior cover 9 covers a machine room. A battery structure body 30 (FIG. 2) and the like are arranged in the machine room.

### Construction of Revolution Frame and Battery Structure Body

A construction of a revolution frame 20 and battery structure body 30 in electric excavator 100 shown in FIG. 1 will now be described with reference to FIGS. 2 to 4.

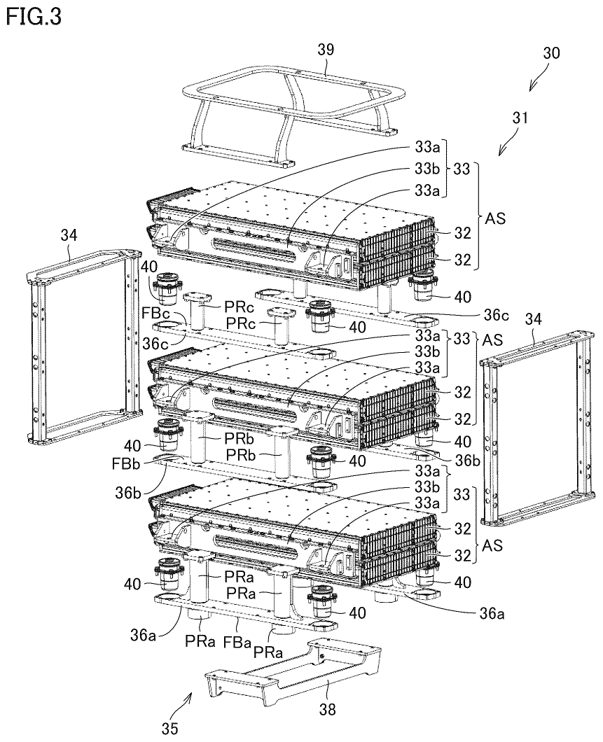

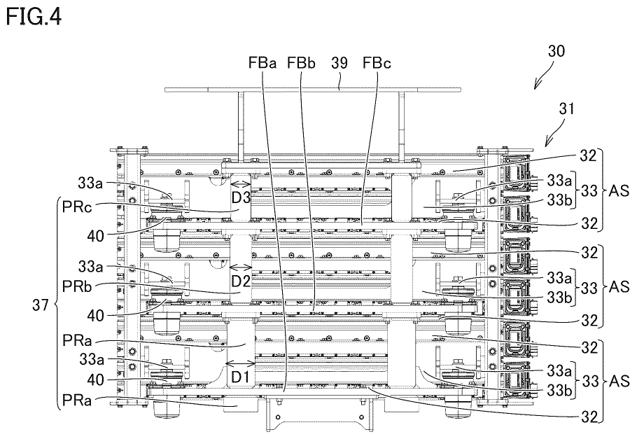

FIG. 2 is a perspective view showing a construction of the battery structure body and the revolution frame in the electric excavator shown in FIG. 1. FIG. 3 is an exploded perspective view of the battery structure body shown in FIG. 2. FIG. 4 is a rear view showing a construction of the battery structure body shown in FIG. 2.

As shown in FIG. 2, revolving unit 3 (FIG. 1) includes revolution frame 20. Revolution frame 20 revolves with respect to travel unit 5 (FIG. 1) around revolution axis RX. Revolution frame 20 includes a center frame CF, a left deck DL, and a right deck DR. Center frame CF is located substantially in the center in the lateral direction of revolution frame 20. Left deck DL is arranged on the left of center frame CF. Right deck DR is arranged on the right of center frame CF.

Revolution frame 20 includes a bottom plate BP and a pair of main beams MB. One and the other of the pair of main beams MB are arranged as being opposed to each other at a distance in the lateral direction. Each of the pair of main beams MB protrudes upward from bottom plate BP.

Each of the pair of main beams MB extends in the forward/rearward direction in a central portion in the lateral direction of revolution frame 20. The central portion means a region where center frame CF of revolution frame 20 is arranged. Each of the pair of main beams MB is arranged in center frame CF. The pair of main beams MB is, for example, in parallel to each other. Each of the pair of main beams extends to a rearmost end of center frame CF.

The pair of main beams MB supports work implement 2 (FIG. 1). Center frame CF thus supports work implement 2. Each of the pair of main beams MB is provided with through holes TH1 and TH2. Boom foot pin 13 is inserted in through hole TH1. Boom foot pin 13 rotatably supports boom 6 (FIG. 1) on the pair of main beams MB.

A pin (not shown) that supports boom cylinder 10 (FIG. 1) is inserted in through hole TH2. This pin rotatably supports boom cylinder 10 on main beams MB.

Battery structure body 30 is arranged in a rear end portion of revolution frame 20. Battery structure body 30 is arranged on upper ends of the pair of main beams MB.

As shown in FIG. 3, battery structure body 30 includes a battery frame 31, a frame body 35, and a plurality of damper mounts (damping members) 40. Battery frame 31 includes at least one battery assembly (for example, three battery assemblies) AS and at least one frame (for example, two frames) 34.

Battery assembly AS includes at least one battery pack (for example, two battery packs) 32 and at least one bracket body 33 (for example, two bracket bodies) 33. Two battery packs 32 are vertically layered. Two vertically layered battery packs 32 are fixed to each other, for example, by two bracket bodies 33.

One of two bracket bodies 33 is arranged in front of two battery packs 32 and the other of two bracket bodies 33 is arranged in the rear of two battery packs 32. Bracket body 33 is fixed to each of lower battery pack 32 and upper battery pack 32, for example, with a bolt.

Battery pack 32 includes, for example, a plurality of battery modules. Each of the plurality of battery modules includes, for example, a plurality of battery cells (unit batteries). A positive electrode and a negative electrode are alternately connected in the plurality of battery cells in a battery module.

Bracket body 33 includes at least one bracket (for example, two brackets) 33a and a support plate 33b. Support plate 33b is formed, for example, from a flat plate. One of two brackets 33a is arranged at one longitudinal end of support plate 33b and the other of two brackets 33a is arranged at the other longitudinal end of support plate 33b. Each of two brackets 33a is fixed to support plate 33b, for example, by welding. Each of two brackets 33a protrudes from support plate 33b. Each of two brackets 33a is a portion to be attached to a damper mount 40.

A plurality of (for example, three) battery assemblies AS are layered in the upward/downward direction. Specifically, three battery assemblies AS which are battery assembly AS in a lowermost stage, battery assembly AS in an intermediate stage, and battery assembly AS in an uppermost stage are layered in the upward/downward direction. In battery structure body 30, for example, six battery packs 32 are thus vertically layered. A layered structure of three battery assemblies AS is fixed by two frames 34.

Each of two frames 34 is, for example, in a rectangular frame shape. Each of two frames 34 is attached, for example, to a lateral end of the layered structure of the plurality of battery assemblies AS. In other words, one of two frames 34 is attached to one lateral end of the layered structure of the plurality of battery assemblies AS and the other of two frames 34 is attached to the other lateral end of the layered structure of the plurality of battery assemblies AS.

Each of two frames 34 surrounds, for example, (front, rear, upper, and lower sides of) the layered structure of three battery assemblies AS. Two frames thus fix six battery packs 32 included in the layered structure of three battery assemblies AS by surrounding the same. Frame 34 is fixed to both of bracket 33a and support plate 33b, for example, with such a fastening member as a bolt.

While the plurality of battery assemblies AS are fixed by two frames 34, a plurality of (for example, six) brackets 33a located in front of battery packs 32 protrude forward from support plates 33b. The plurality of brackets 33a located in front of battery packs 32 are arranged, for example, in two rows in the lateral direction and three brackets are arranged in the upward/downward direction in each row.

While the plurality of battery assemblies AS are fixed by two frames 34, a plurality of (for example, six) brackets 33a located in the rear of battery packs 32 protrude rearward from support plates 33b. The plurality of brackets 33a located in the rear of battery packs 32 are arranged, for example, in two rows in the lateral direction and three brackets are arranged in the upward/downward direction in each row.

Battery frame 31 is supported on frame body 35 with a plurality of (for example, twelve) damper mounts 40 being interposed. Frame body 35 includes pairs of front and rear frame members 36a to 36c, an attachment frame 38, and a connection frame 39.

One of the pair of front and rear frame members 36a is arranged in front of battery frame 31 and the other of the pair of front and rear frame members 36a is arranged in the rear of battery frame 31. Each of the pair of front and rear frame members 36a includes a pillar portion PRa and a frame plate FBa. Frame plate FBa is, for example, in a form of a flat plate. Pillar portion PRa includes a portion that protrudes upward from an upper surface of frame plate FBa and a portion that protrudes downward from a lower surface of frame plate FBa. Pillar portion PRa is fixed to frame plate FBa, for example, by welding. Pillar portion PRa is provided at each of opposing longitudinal ends of frame plate FBa. Pillar portion PRa may be, for example, in a shape of a pillar (a shape of a column, a shape of a prism, or the like) or in a hollow shape (a cylindrical shape, a shape of a hollow prism, or the like). One of the pair of front and rear frame members 36b is arranged in front of battery frame 31 and the other of the pair of front and rear frame members 36b is arranged in the rear of battery frame 31. Each of the pair of front and rear frame members 36b includes a pillar portion PRb and a frame plate FBb. Frame plate FBb is, for example, in a form of a flat plate. Pillar portion PRb protrudes upward from an upper surface of frame plate FBb. Pillar portion PRb is fixed to frame plate FBb, for example, by welding. Pillar portion PRb is provided at each of opposing longitudinal ends of frame plate FBb. Pillar portion PRb may be, for example, in a shape of a pillar (a shape of a column, a shape of a prism, or the like) or in a hollow shape (a cylindrical shape, a shape of a hollow prism, or the like).

One of the pair of front and rear frame members 36c is arranged in front of battery frame 31 and the other of the pair of front and rear frame members 36c is arranged in the rear of battery frame 31. Each of the pair of front and rear frame members 36c includes a pillar portion PRc and a frame plate FBc. Frame plate FBc is, for example, in a form of a flat plate. Pillar portion PRc protrudes upward from an upper surface of frame plate FBc. Pillar portion PRc is fixed to frame plate FBc, for example, by welding. Pillar portion PRc is provided at each of opposing longitudinal ends of frame plate FBc. Pillar portion PRc may be, for example, in a shape of a pillar (a shape of a column, a shape of a prism, or the like) or in a hollow shape (a cylindrical shape, a shape of a hollow prism, or the like).

Frame member 36b is arranged on frame member 36a. Frame member 36c is arranged on frame member 36b.

Frame member 36a is fixed to frame member 36b, for example, with such a fastening member as a bolt. Specifically, an upper end of pillar portion PRa in frame member 36a is fixed to frame plate FBb of frame member 36b, for example, with such a fastening member as a bolt. While frame member 36a and frame member 36b are fixed to each other, pillar portion PRb in frame member 36b is located directly on pillar portion PRa in frame member 36a. In this state, pillar portion PRa and pillar portion PRb are arranged, for example, coaxially with each other.

Frame member 36b is fixed to frame member 36c, for example, with such a fastening member as a bolt. Specifically, an upper end of pillar portion PRb in frame member 36b is fixed to frame plate FBc of frame member 36c, for example, with such a fastening member as a bolt. While frame member 36b and frame member 36c are fixed to each other, pillar portion PRc in frame member 36c is located directly on pillar portion PRb in frame member 36b. In this state, pillar portion PRb and pillar portion PRc are arranged, for example, coaxially with each other.

Coaxially arranged pillar portions PRa, PRb, and PRc constitute a single pillar 37 (FIG. 2). Frame body 35 includes at least one pillar (for example, four pillars) 37. At least one pillar 37 includes a plurality of (for example, two) pillars 37 (first pillars) arranged in front of battery frame 31 as shown in FIG. 2 and a plurality of (for example, two) pillars 37 (second pillars) arranged in the rear of battery frame 31 as shown in FIG. 4 (A).

As shown in FIG. 2, each of frame plates FBa, FBb, and FBc arranged in front of battery frame 31 is attached to each of the plurality of (for example, two) pillars 37 (first pillars) arranged in front of battery frame 31. The plurality of frame plates FBa, FBb, and FBc arranged in front of battery frame 31 are layered in the upward/downward direction.

As shown in FIG. 4, each of frame plates FBa, FBb, and FBc arranged in the rear of battery frame 31 is attached to each of the plurality of (for example, two) pillars 37 (second pillars) arranged in the rear of battery frame 31. The plurality of frame plates FBa, FBb, and FBc arranged in the rear of battery frame 31 are layered in the upward/downward direction.

As shown in FIGS. 2 and 4, each of the plurality of pillars 37 plays a role to bear a load applied to battery frame 31, to prevent interference between battery frame 31 and another component, and to prevent a self-weight of electric excavator 100 from being applied to battery frame 31 in the event of overturn of electric excavator 100.

As shown in FIG. 4, pillar 37 is provided with a lower portion and an upper portion located above the lower portion. Specifically, with pillar portion PRa being defined as the lower portion of pillar 37, pillar portions PRb and PRc fall under the upper portion of pillar 37. Alternatively, with pillar portion PRb being defined as the lower portion of pillar 37, pillar portion PRc falls under the upper portion of pillar 37.

The lower portion of pillar 37 is larger in diameter than the upper portion of pillar 37. Specifically, a diameter D1 of pillar portion PRa is larger than a diameter D2 of pillar portion PRb and a diameter D3 of pillar portion PRc. Diameter D2 of pillar portion PRb is larger than diameter D3 of pillar portion PRc.

As shown in FIG. 3, an assembly of frame members 36a, 36b, and 36c is arranged on each of front and rear sides of battery frame 31. The assembly of frame members 36a, 36b, and 36c arranged in front of battery frame 31 and the assembly of frame members 36a, 36b, and 36c arranged in the rear of battery frame 31 are connected to each other by attachment frame 38 and connection frame 39.

Attachment frame 38 is arranged under battery frame 31. Attachment frame 38 is attached to both of frame member 36a arranged in front of battery frame 31 and frame member 36a arranged in the rear of battery frame 31, for example, with such a fastening member as a bolt. Specifically, attachment frame 38 is attached to both of frame plate FBa of frame member 36a arranged in front of battery frame 31 and frame plate FBa of frame member 36a arranged in the rear of battery frame 31.

Connection frame 39 is arranged above battery frame 31. Connection frame 39 is fixed to both of frame member 36c arranged in front of battery frame 31 and frame member 36c arranged in the rear of battery frame 31, for example, with such a fastening member as a bolt. Specifically, connection frame 39 is fixed to each of pillar portion PRc in frame member 36c arranged in front of battery frame 31 and pillar portion PRc in frame member 36c arranged in the rear of battery frame 31.

Battery frame 31 is supported on frame body 35 with the plurality of (for example, twelve) damper mounts 40 being interposed. Damper mount 40 suppresses transfer of vibration, shock, or the like from frame body 35 to battery frame 31, for example, by damping vibration, shock, or the like.

Damper mount 40 may be composed of an elastic material (for example, rubber) or formed from an elastic member (for example, a coil spring), or it may be a feature in which viscous fluid (for example, silicone oil) is sealed. Alternatively, damper mount 40 may be composed, for example, of any combination of the elastic material, the elastic member, and the feature in which viscous fluid is sealed.

The plurality of damper mounts 40 include a plurality of (for example, six) damper mounts 40 located in front of battery frame 31 and a plurality of (for example, six) damper mounts 40 located in the rear of battery frame 31. Each of six damper mounts 40 located in front of battery frame 31 is arranged between each of frame plates FBa, FBb, and FBc located in front of battery packs 32 and bracket 33a. Each of six damper mounts 40 located in the rear of battery frame 31 is arranged between each of frame plates FBa, FBb, and FBc located in the rear of battery packs 32 and bracket 33a.

Damper mount 40 is supported on each of frame plates FBa, FBb, and FBc by being inserted in a through hole in each of frame plates FBa, FBb, and FBc and then fixed thereto, for example, with such a fastening member as a bolt. A portion of damper mount 40 that protrudes upward from each of frame plates FBa, FBb, and FBc is fixed to a lower surface of bracket 33a. Damper mount 40 is fixed to bracket 33a, for example, with such a fastening member as a bolt.

### Arrangement of Bracket 33a

Arrangement of bracket 33a will now be described with reference to FIGS. 2 and 4 to 7.

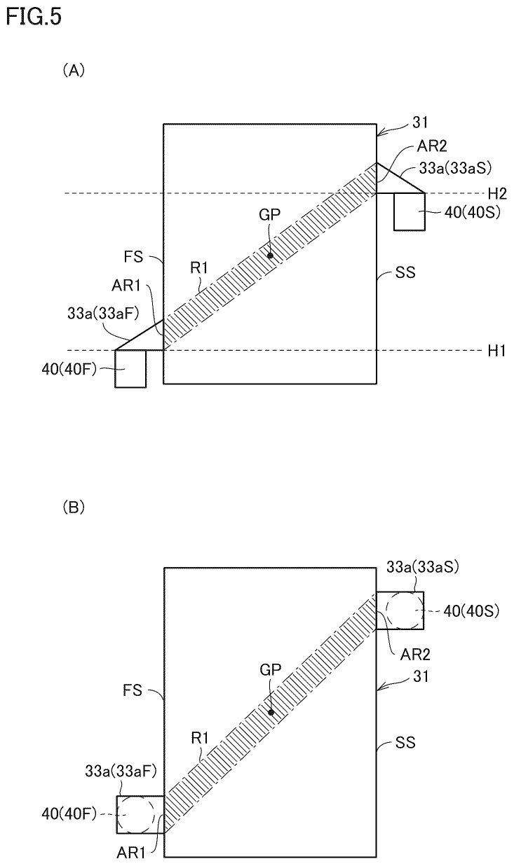

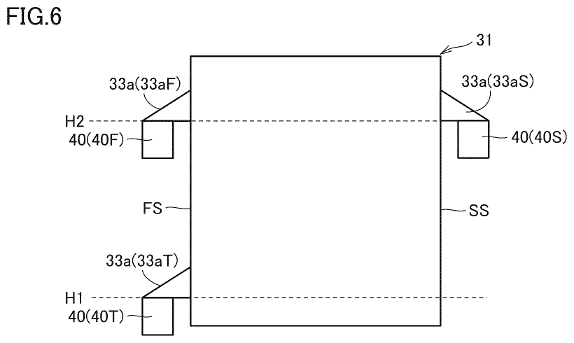

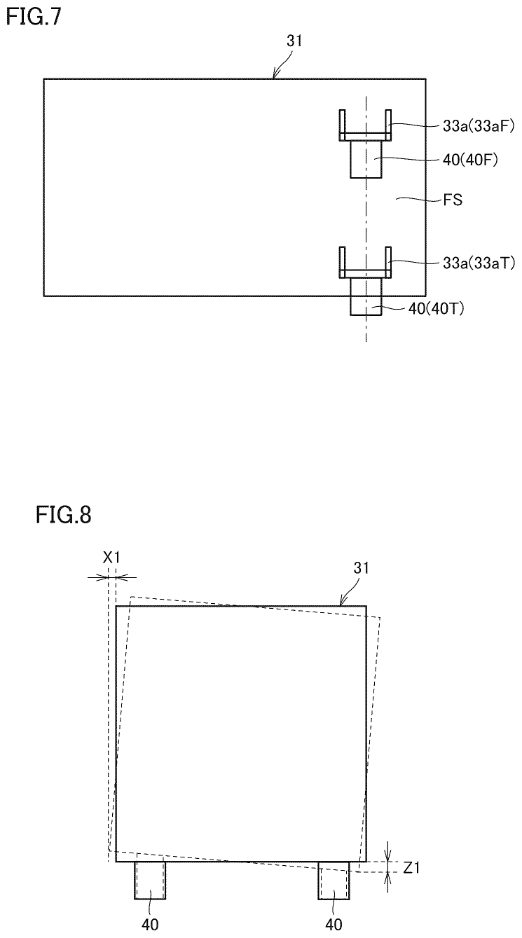

FIG. 5 is (A) a side view and (B) a plan view showing a first example of arrangement of the bracket in the battery frame. FIG. 6 is a side view showing a second example of arrangement of the bracket in the battery frame. FIG. 7 is a front view showing a third example of arrangement of the bracket in the battery frame.

As shown in FIG. 5 (A) and (B), a first bracket 33aF and a second bracket 33aS are arranged on surfaces of battery frame 31 opposite to each other. In this case, when first bracket 33aF is arranged on a side of a first surface FS of battery frame 31, second bracket 33aS is arranged on a side of a second surface SS of battery frame 31.

First surface FS may be a front surface of battery frame 31 and the second surface may be a rear surface of battery frame 31. Alternatively, first surface FS may be the rear surface of battery frame 31 and the second surface may be the front surface of battery frame 31.

Alternatively, first surface FS may be a right side surface of battery frame 31 and second surface SS may be a left side surface of battery frame 31. Alternatively, first surface FS may be the left side surface of battery frame 31 and second surface SS may be the right side surface of battery frame 31.

As shown in FIGS. 5 (A) and (B), first bracket 33aF and second bracket 33aS arranged on the surfaces opposite to each other may be arranged at height positions different from each other. First bracket 33aF is arranged at a position lower in the upward/downward direction than second bracket 33aS.

As shown in FIGS. 2 and 4, when bracket 33a of battery assembly AS located in the lowermost stage corresponds to first bracket 33aF, bracket 33a of battery assembly AS in the intermediate stage or the uppermost stage corresponds to second bracket 33aS. Alternatively, when bracket 33a of battery assembly AS in the intermediate stage corresponds to first bracket 33aF, bracket 33a of battery assembly AS in the uppermost stage corresponds to second bracket 33aS.

As shown in FIG. 5 (A), the height position of first bracket 33aF is a height position H1 of a portion (for example, a lower surface) of first bracket 33aF to which a first damper mount 40F (first damping member) is attached. The height position of second bracket 33aS is a height position H2 of a portion (for example, a lower surface) of second bracket 33aS to which a second damper mount 40S (second damping member) is attached. Therefore, a state in which height position H1 is lower than height position H2 is a state in which the height position of first bracket 33aF is lower than the height position of second bracket 33aS.

Bracket 33a arranged on first surface FS of battery frame 31 protrudes toward a side opposite to second surface SS with respect to first surface FS, and bracket 33a arranged on second surface SS of battery frame 31 protrudes toward a side opposite to first surface FS with respect to second surface SS. Specifically, bracket 33a arranged on the front surface of battery frame 31 protrudes from the front surface of battery frame 31 toward a front side which is opposite to the rear surface. Bracket 33a arranged on the rear surface of battery frame 31 protrudes from the rear surface of battery frame 31 toward a rear side which is opposite to the front surface.

As shown in FIGS. 5 (A) and (B), a center of gravity GP of battery frame 31 is preferably located in a region (a hatched region in the figure) R1 lying between a first attachment region AR1 where first bracket 33aF is attached to battery frame 31 and a second attachment region AR2 where second bracket 33aS is attached to battery frame 31.

Each of first attachment region AR1 and second attachment region AR2 means a region in the upward/downward direction where bracket 33a is attached to support plate 33b in the side view shown in FIG. 5 (A) or a front view (or a rear view). Each of first attachment region AR1 and second attachment region AR2 means a region in the lateral direction or the forward/rearward direction where bracket 33a is attached to support plate 33b in the plan view shown in FIG. 5 (B).

As shown in FIG. 6, a third bracket 33aT may be arranged on the same surface where first bracket 33aF or second bracket 33aS is arranged. For example, while first bracket 33aF is arranged on first surface FS and second bracket 33aS is arranged on second surface SS, third bracket 33aT may be arranged on the same surface (first surface FS) where first bracket 33aF is arranged.

In this case, a height position (for example, H1) where third bracket 33aT is arranged may be a height position lower than the height position (for example, H2) where first bracket 33aF is arranged. Alternatively, the height position where third bracket 33aT is arranged may be a height position higher than the height position where first bracket 33aF is arranged. Third bracket 33aT may be located at the same height position as first bracket 33aF. Second bracket 33aS may be located at the same height position (for example, H2) as first bracket 33aF.

Third bracket 33aT is supported on frame body 35 with a third damper mount 40T (third damping member) being interposed. The height position of third bracket 33aT is a height position of a portion (for example, a lower surface) of third bracket 33aT to which third damper mount 40T is attached.

As shown in FIG. 7, third bracket 33aT may be arranged directly under or directly above first bracket 33aF or second bracket 33aS. When third bracket 33aT is arranged on the same surface (first surface FS) where first bracket 33aF is arranged, third bracket 33aT may be arranged directly under or directly above first bracket 33aF.

Alternatively, when third bracket 33aT is arranged on the same surface (second surface SS) where second bracket 33aS is arranged, third bracket 33aT may be arranged directly under or directly above second bracket 33aS.

While first bracket 33aF is arranged on first surface FS and second bracket 33aS is arranged on second surface SS, another bracket may be arranged on a third surface different from first surface FS and second surface SS. Another bracket arranged on the third surface may be a single bracket or a plurality of brackets. Another bracket arranged on the third surface is supported on frame body 35 with a damper mount (damping member) being interposed.

### Effects

Effects of the present embodiment will now be described in comparison to a comparative example shown in FIG. 8.

As shown in FIG. 8, in the comparative example, a plurality of damper mounts 40 are arranged below battery frame 31. In such a construction in the comparative example, when an acceleration is applied to electric work machine 100, leaning (tilt) toward front, rear, left, and right sides of battery frame 31 tends to occur as shown with a dashed line in the figure. When leaning of battery frame 31 is great, battery frame 31 may interfere with a component (a harness, a pipe, or the like) therearound. Therefore, a large space on the front, rear, left, and right sides of battery frame 31 should be secured. Specifically, at least a space larger than a dimension X1 shown in the figure should be secured, which leads to poor efficiency in use of the space.

In addition, when leaning of battery frame 31 becomes great, a great uneven load is applied to damper mount 40, which increases a stroke Z1 of damper mount 40. When leaning of battery frame 31 becomes greater, revolution frame 20 swings and a sensory aspect to sense an operation by an operator deteriorates.

In contrast, according to the present embodiment, as shown in FIGS. 5 (A) and (B), first bracket 33aF is attached to first surface FS and second bracket 33aS is attached to second surface SS. Since battery frame 31 can thus be supported by both of first surface FS and second surface SS opposed to each other, leaning of battery frame 31 can be suppressed.

According to the present embodiment, as shown in FIGS. 5 (A) and (B), first bracket 33aF protrudes toward the side opposite to second surface SS and second bracket 33aS protrudes toward the side opposite to first surface FS. Protruding portions of first bracket 33aF and second bracket 33aS can thus be supported by first damper mount 40F and second damper mount 40S, respectively.

In the present embodiment, as shown in FIG. 5 (A), first bracket 33aF and second bracket 33aS are arranged at height positions different from each other. Since battery frame 31 is thus supported at the height positions different from each other, leaning of battery frame 31 can further be suppressed.

According to the present embodiment, as shown in FIGS. 5 (A) and (B), center of gravity GP of battery frame 31 is located in region (hatched region) R1 lying between first attachment region AR1 where first bracket 33aF is attached to battery frame 31 and second attachment region AR2 where second bracket 33aS is attached to battery frame 21. Leaning of battery frame 31 can thus further be suppressed.

According to the present embodiment, as shown in FIG. 6, third bracket 33aT is arranged on the same surface where first bracket 33aF or second bracket 33aS is arranged. Since battery frame 31 is thus supported at a plurality of locations on the same surface, leaning of battery frame 31 can further be suppressed.

According to the present embodiment, as shown in FIG. 7, third bracket 33aT is arranged directly under or directly above first bracket 33aF or second bracket 33aS. Leaning of battery frame 31 can thus further be suppressed.

According to the present embodiment, as shown in FIG. 4, pillar 37 couples the plurality of frame plates FBa, FBb, and FBc layered in the upward/downward direction to one another. The load applied by battery frame 31 to each of the plurality of frame plates FBa, FBb, and FBc can thus be born by pillar 37.

According to the present embodiment, as shown in FIG. 4, the lower portion of pillar 37 is larger in diameter than the upper portion of pillar 37. Specifically, diameter D1 of pillar portion PRa is larger than diameter D2 of pillar portion PRb and diameter D3 of pillar portion PRc. Diameter D2 of pillar portion PRb is larger than diameter D3 of pillar portion PRc. As the lower portion of pillar 37 is larger in diameter than the upper portion of pillar 37, support of battery structure body 30 by pillar 37 is stabilized.

According to the present embodiment, as shown in FIG. 3, battery frame 31 includes the plurality of battery packs 32 and frame 34 that fixes the plurality of battery packs 32 by surrounding the same. The plurality of battery packs 32 can thus more securely be fixed to frame 34.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

1 main body; 2 work implement; 3 revolving unit; 4 operator's cab; 4S operator's seat; 5 travel unit; 5Cr crawler belt; 5M travel motor; 6 boom; 7 arm; 8 bucket; 9 exterior cover; 10 boom cylinder; 11 arm cylinder; 12 bucket cylinder; 13 boom foot pin; 14 boom top pin; 15 arm top pin; 17 bucket link; 20 revolution frame; 30 battery structure body; 31 battery frame; 32 battery pack; 33 bracket body; 33a bracket; 33aF first bracket; 33aS second bracket; 33aT third bracket; 33b support plate; 34 frame; 35 frame body; 36a, 36b, 36c frame member; 37 pillar; 38 attachment frame; 39 connection frame; 40 damper mount; 40F first damper mount; 40S second damper mount; 40T third damper mount; 100 electric excavator; AR1 first attachment region; AR2 second attachment region; AS battery assembly; BP bottom plate; CF center frame; DL left deck; DR right deck; FBa, FBb, FBc frame plate; FS first surface; GP center of gravity; PRa, PRb, PRc pillar portion; RX revolution axis; SS second surface; TH1, TH2 through hole.

1. An electric work machine comprising:
a first damping member and a second damping member; and
a battery frame including a first bracket supported by the first damping member and a second bracket supported by the second damping member, wherein
the battery frame is provided with a first surface and a second surface opposed to each other, and
the first bracket is arranged on the first surface and the second bracket is arranged on the second surface.

2. The electric work machine according to claim 1, wherein
the first bracket protrudes toward a side opposite to the second surface and the second bracket protrudes toward a side opposite to the first surface.

3. The electric work machine according to claim 1, wherein
the first bracket and the second bracket are arranged at height positions different from each other.

4. The electric work machine according to claim 1, wherein
the battery frame has a center of gravity located in a region lying between a first attachment region where the first bracket is attached to the battery frame and a second attachment region where the second bracket is attached to the battery frame.

5. The electric work machine according to claim 1, further comprising a third damping member, wherein
the battery frame further includes a third bracket supported by the third damping member, and
the third bracket is arranged on a same surface where the first bracket or the second bracket is arranged.

6. The electric work machine according to claim 5, wherein
the third bracket is arranged directly under or directly above the first bracket or the second bracket.

7. The electric work machine according to claim 1, further comprising:
a plurality of frame plates layered in an upward/downward direction; and
a pillar attached to the plurality of frame plates layered in the upward/downward direction.

8. The electric work machine according to claim 7, wherein
the pillar is provided with a lower portion and an upper portion located above the lower portion, and
the lower portion is larger in diameter than the upper portion.

9. The electric work machine according to claim 1, wherein
the battery frame includes a plurality of battery packs and a frame that fixes the plurality of battery packs by surrounding the plurality of battery packs.
